(19) United States
(12) Patent Application Publication
(10) Pub. No.: US 2020/0136894 A1
(43) Pub. Date: Apr. 30, 2020

(54) SYSTEM AND METHOD FOR ESTABLISHING RELIABLE TIME-SENSITIVE NETWORKS

(71) Applicant: General Electric Company, Schenectady, NY (US)

(72) Inventors: Stephen Francis Bush, Niskayuna, NY (US); Guillaume Mantelet, Oakbank (CA)

(21) Appl. No.: 16/281,455

(22) Filed: Feb. 21, 2019

Related U.S. Application Data
(60) Provisional application No. 62/749,904, filed on Oct. 24, 2018.

(51) Int. Cl. H04L 12/24; H04L 12/939

(52) U.S. Cl. CPC H04L 41/0668; H04L 49/552

(57) ABSTRACT

A communication system includes one or more processors that determine a communication risk value for each path of multiple paths within a time-sensitive network. The multiple paths are defined by multiple nodes and links that communicatively connect the nodes. The processors establish a redundant path of the paths that bypasses a low reliability path of the paths. The redundant path includes at least one different link or node from the low reliability path. The processors control the time-sensitive network to communicate duplicate copies of a data frame in parallel along both the redundant path and the low reliability path to increase a likelihood that the data frame is received at a listening device from a publishing device within a designated time window according to a schedule of the time-sensitive network.

### CROSS-REFERENCE TO RELATED APPLICATIONS

This application claims priority to U.S. Provisional Application No. 62/749,904, which was filed on 24 Oct. 2018, and the entire disclosure of which is incorporated herein by reference.

### FIELD

The subject matter described herein relates to communication networks.

### BACKGROUND

The IEEE 802.1 Time-Sensitive Networking Task Group has created a series of standards that describe how to implement deterministic, scheduled Ethernet frame delivery within an Ethernet network. Time-sensitive networking benefits from advances in time precision and stability to create efficient, deterministic traffic flows in an Ethernet network. Time-sensitive networks can be used in safety critical environments, such as control systems for automated industrial systems. In these environments, timely and fast control of machinery is needed to ensure that operators and equipment at or near the machinery being controlled are not hurt or damaged.

Ethernet-based networks are generally assumed to be perfectly reliable and able to guarantee the successful communication of all frames. But, there is a risk of communication failures, such as failures caused by malfunctioning hardware in the network attributable to age or damage. In a time-sensitive network, a communication failure involving the transmission of a single frame can result in a failure to meet the time delivery requirements of time-sensitive communications, which may cause damage or harm in safety critical environments.

### BRIEF DESCRIPTION

In one embodiment, a communication system includes one or more processors configured to determine a communication risk value for each path of multiple paths between nodes and links between the nodes within a time-sensitive network. The one or more processors also are configured to determine that at least one of the paths is a low reliability path due to the low reliability path having a communication risk value than one or more other paths in the time-sensitive network. The one or more processors also are configured to establish a redundant path of the paths that bypasses the low reliability path such that the redundant path includes at least one different link or node from the low reliability path. The one or more processors also are configured to control the time-sensitive network to communicate duplicate copies of a data frame in parallel along both the redundant path and the low reliability path between a publishing device and a listening device within a designated time window according to a schedule of the time-sensitive network.

In one embodiment, a method includes determining a communication risk value for each path of multiple paths between nodes and links between the nodes within a time-sensitive network, determining that at least one of the paths is a low reliability path due to the low reliability path having a greater communication risk value than one or more other paths in the time-sensitive network, establishing a redundant path of the paths that bypasses the low reliability path such that the redundant path includes at least one different link or node from the low reliability path, and directing the time-sensitive network to communicate duplicate copies of a data frame in parallel along both the redundant path and the low reliability path between a publishing device and a listening device within a designated time window according to a schedule of the time-sensitive network.

In one embodiment, a communication system includes a time-sensitive network including plural network paths formed by nodes interconnected by communication links. The nodes are configured to receive and forward data frames of a message between each other along the communication links to communicate the message originating at a publishing device to one or more listening devices within a designated time window according to a schedule of the time-sensitive network. The communication system also includes one or more processors configured to determine communication risk values for two or more of the network paths within a time-sensitive network that communicatively couple the publishing device with the one or more listening devices. The one or more processors also are configured to compare the communication risk values of the paths and to establish a redundant path that communicatively couples the publishing device with the one or more listening devices from one or more of the nodes and two or more of the communication links already existing in the time-sensitive network based on the communication risk values that are compared. The redundant path is established to bypass at least one other network path of the network paths between the publishing device and the one or more listening devices. The one or more processors also are configured to control the time-sensitive network to communicate duplicate copies of at least one of the data frames in parallel along both the redundant path and the at least one other network path from the publishing device to the one or more listening devices within the designated time window of the schedule of the time-sensitive network.

### BRIEF DESCRIPTION OF THE DRAWINGS

The present inventive subject matter will be better understood from reading the following description of non-limiting embodiments, with reference to the attached drawings, wherein below:

FIG. 1 is a schematic illustration of a powered system according to an embodiment;

FIG. 2 schematically illustrates one embodiment of a communication system that includes a control system and a time-sensitive network according to an embodiment;

FIG. 3 illustrates the time-sensitive network of FIG. 2 with multiple computing devices and traffic flow paths communicatively connecting the computing devices; and

FIG. 4 illustrates a flowchart of one embodiment of a method for communicating, and more specifically to reliably communicating messages in a time-sensitive network.

### DETAILED DESCRIPTION

One or more embodiments of the inventive subject matter described herein relate to systems and methods that use redundant traffic flow paths (e.g., redundant paths) for transmitting data frames in time-sensitive networking to increase reliability. The systems and methods establish the redundant path(s) to bypass corresponding paths, referred to as low reliability paths, which are determined to be less reliable than one or more other paths in the time-sensitive network. The time-sensitive network may be operated such that the information (e.g., a data frame) scheduled for transmission along a low reliability path is transmitted in parallel along a corresponding redundant path to increase the likelihood that the information is received at a designated destination (e.g., a listener device) within a pre-defined time window or slot according to the schedule.

In one or more embodiments, a control device of the time-sensitive network, such as a scheduler and/or configurator, is configured to account for the reliability (e.g., likelihood or probability of failure) of the time-sensitive network when establishing and/or configuring traffic flow paths through the time-sensitive network. For example, the control device establishes one or more redundant flow paths, resulting in parallel transmission of duplicate information, based on a reliability analysis on the time-sensitive network. The reliability analysis may involve scoring and/or comparing perceived reliabilities of existing traffic flow paths, which are defined by hardware components including nodes and links. The control device is configured to establish or define the one or more redundant paths based on the reliability analysis in order to meet designated network-wide reliability targets or requirements. For example, the control device may utilize network topology information to compute reliability values for existing flow paths and may improve the network reliability by establishing one or more redundant flow paths to satisfy the network reliability target.

At least one technical effect of the subject matter described herein provides for increased reliability (e.g., a greater success rate) in the communication of time-sensitive packets in a time-sensitive network. The increased reliability results in an increased likelihood that information transmitted through the time-sensitive network will be received at designated destinations within designated time windows according to a schedule of the time-sensitive network. The increased reliability can enhance confidence in the timely receipt of time-critical information through the network, especially in safety critical environments and applications that rely on timely and fast control of machinery to prevent harm and/or damage.

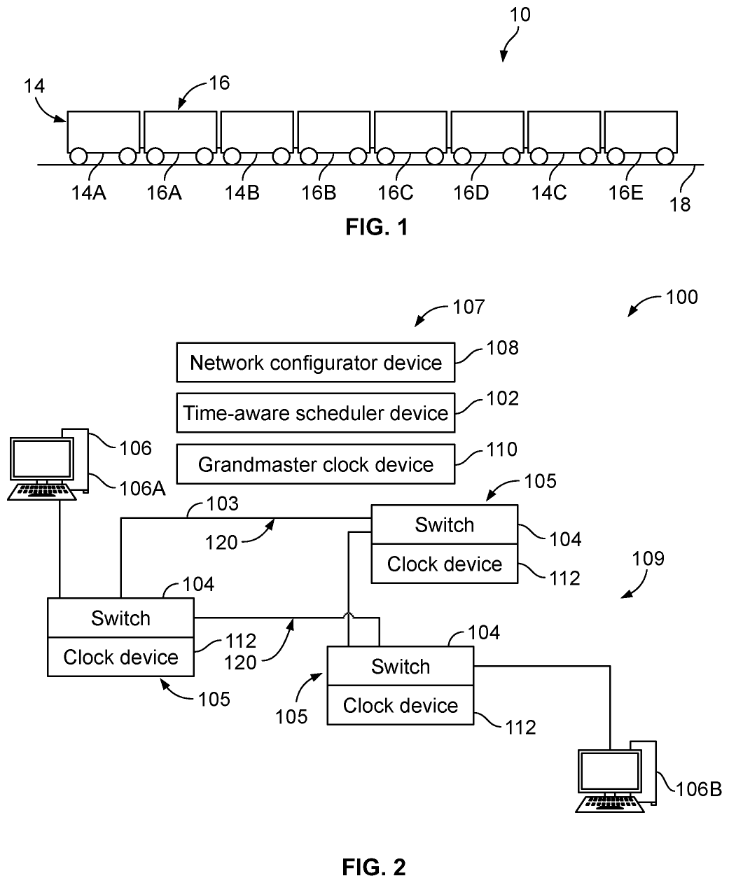

FIG. 1 is a schematic illustration of a powered system 10 according to an embodiment. The powered system 10 is shown and described as a vehicle system formed from several vehicles 14, 16, but optionally can be another type of non-vehicular system. The vehicles 14 (e.g., the vehicles 14A-C) represent propulsion-generating vehicles, such as vehicles that generate tractive effort or power in order to propel the vehicle system 10 along the route 18. In one or more embodiments, the vehicle system 10 is a rail-based vehicle system 10 that moves along rails representing the route 18. The vehicles 14 can represent locomotives. The vehicles 16 (e.g., the vehicles 16A-E) can represent non-propulsion generating vehicles, such as vehicles that do not generate tractive effort or power. In an embodiment, the vehicles 16 can represent rail cars. Alternatively, the vehicles 14, 16 may represent other types of vehicles. In another embodiment, one or more of the individual vehicles 14 and/or 16 represent a group of vehicles, such as a consist of locomotives or other vehicles. While the description herein focuses on the vehicles, not all embodiments of the inventive systems and methods are limited to use with or in connection with vehicles.

FIG. 2 schematically illustrates one embodiment of a communication system 100 that includes a control system 107 and a time-sensitive network 109. The components shown in FIG. 2 represent hardware circuitry that includes and/or is connected with one or more processors (e.g., one or more microprocessors, field programmable gate arrays, and/or integrated circuits) that operate to perform the functions described herein. The components of the communication system 100 can be communicatively coupled with each other by one or more wired and/or wireless connections. Not all connections between the components of the communication system 100 are shown herein.

The communication system 100 is onboard or disposed within the powered system 10 shown in FIG. 1. For example, the components of the control system 107 and the components of the time-sensitive network 109 may be disposed onboard one or more of the vehicles 14A-C-in of the powered system 10. Optionally, the vehicles 14 can represent electronic components 14 of the powered system 10. For example, the components 14 can be computers, sensors, input devices (e.g., microphones, touchscreens, keyboards, etc.), output devices (e.g., display devices, speakers, etc.), or the like. The communication system 100 is utilized to transmit and receive communications (e.g., control signals and messages) onboard the powered system 10, such as between devices on or within the same component 14, 16 and/or between devices disposed on or within different components 14, 16. While the communication system 100 is described as being disposed onboard the powered system 10 shown in FIG. 1, alternatively, the communication system 100 may be disposed onboard or within another type of electronic component, such as an automobile, a marine vessel, a mining vessel, another off-highway vehicle (e.g., a vehicle that is not legally permitted or that is not designed for travel along public roadways), a server, a television, a satellite, etc. In yet another embodiment, the communication system 100 may be installed off-board a vehicle, such as installed in an industrial setting (e.g., factory, manufacturing plant, or the like). For example, the communication system 100 optionally may be used to provide network communications in systems other than vehicle networks.

The time-sensitive network 109 can be configured to operate according to one or more of the time-sensitive network standards of IEEE, such as the IEEE 802.1AS™-2011 Standard, the IEEE 802.1Q™-2014 Standard, the IEEE 802.1Qbu™-2016 Standard, and/or the IEEE 802.3br™-2016 Standard. Reliability values for each device in the network may be included as Type Length Value (TLV) entities in Logical Link Discovery Protocol (LLDP) messages or as part of a YANG (Yet Another Next Generation) module allowing a standard's-based approach to automatically convey individual part reliability information to the control system 107 (e.g., to a network configurator device 108 thereof).

Time synchronization is critical to the operation of time-sensitive networks and thus the grandmaster and master-slave clock paths also need to be considered in reliability analysis. The IEEE 802.1AS-2011 Standard only considers the quality of the clocks when determining clock interconnectivity (spanning tree). Reliability analysis should also consider the probability of failure of the clocks and the links interconnecting the clocks as well as the cumulative effect of clock noise on synchronization. The network configurator device 108 can guide clock interconnectivity by modifying clock configuration information.

The time-sensitive network 109 includes several nodes 105 formed of network switches 104 and associated clocks 112 (“clock devices” in FIG. 2). While only three nodes 105 are shown in FIG. 2, the time-sensitive network 109 can be formed of many more nodes 105 distributed over a large geographic area. The switches 104 of the nodes 105 may include or represent electrical switches, routers, bridges, hubs, and/or the like. The nodes 105 are communicatively connected to one another via communication links 103 (referred to herein as links 103). The links 103 include or represent physical communication pathways, such as copper wires and/or cables, optical wires and/or cables, Ethernet links, and the like.

The time-sensitive network 109 can be an Ethernet network that communicates data frames (or packets) as signals along traffic flow paths 120 between computing devices 106. The traffic flow paths 120 (referred to herein as paths 120) are defined by the nodes 105 and the links 103. For example, a data frame may be transmitted from a first link 103 to a second link 103 through a node 105 that connects the first and second links 103. The data frames are sent along different corresponding paths 120 according to a schedule of the time-sensitive network 109. The schedule restricts which data frames can be communicated by each of the nodes 105 at different times.

Different data frames (e.g., signals) can be communicated at different repeating scheduled time periods based on traffic classifications of the frames. Some data frames represent messages that are classified as time-critical traffic (referred to herein as time-critical messages) while other data frames represent messages classified as best-effort traffic (referred to herein as best-effort messages). The time-critical messages have a higher priority than the best-effort messages. The time-critical messages may be required to be communicated at or within designated periods of time to ensure the safe operation of a powered system, such as industrial machinery or a vehicle (e.g., locomotive, automobile, off-road truck, or the like). If a time-critical message is not received within the designated time period or window, the lack of timely receipt of the time-critical message may risk harm to people and/or damage. The best-effort messages include data frames that are not required to ensure the safe operation of the powered system, but that are communicated for other purposes (e.g., monitoring operation of components of the powered system).

The computing devices 106 that communicate via the time-sensitive network 109 may be computers, sensors, servers, control devices, input/output devices, traction motor controllers, engine control units, auxiliary load controllers, sensors, and/or the like. The computing devices 106 are disposed onboard the vehicle system 10 shown in FIG. 1. A first computing device 106A of the two devices 106 may be a different type of computing device from a second computing device 106B of the two devices 106. The computing device 106 that generates or inputs a message (defined by one or more data frames) into the time-sensitive network 109 for communication to the other computing device 106 is referred to as a publishing device. The computing device 106 that receives the message output from the time-sensitive network 109 is referred to as a listening device. For example, the first computing device 106A may be the publishing device and the second computing device 106B may be the listening device for a given message transmitted via the time-sensitive network 109. Optionally, the computing devices 106 may be able to function as both publishing devices and listening devices to enable bi-directional communications between the computing devices 106 via the time-sensitive network 109. Although only two computing devices 106 are shown in FIG. 2, the time-sensitive network 109 may enable more than two computing devices 106 (e.g., dozens, hundreds, or thousands) to reliably communicate with one another.

The network control system 107 includes a time-aware scheduler device 102, a centralized network configurator device 108, and a grandmaster clock device 110. The scheduler device 102 generates a schedule that instructs each interface of a node 105 to transmit an Ethernet data frame along a predefined path 120 at a prescheduled time, creating deterministic traffic flows while sharing the same media with legacy, best-effort Ethernet traffic. The time-sensitive network 109 has been developed to support hard, real-time applications where delivery of frames of time-critical traffic must meet tight schedules without causing failure, particularly in life-critical industrial control systems. The scheduler device 102 computes the schedule, and the schedule is installed at each node 105 in the time-sensitive network 109. This schedule dictates when different types or classification of signals are communicated by the switches 104 of the nodes 105. For example, the schedule may dictate that a given switch 104 transmits a time-critical message at a first time or interval, and the switch 104 transmits a best-effort message at a different, second time or interval. The schedule may also dictate arrival time windows or periods within which the data frames are required to be received at a designated listening device, such as the computing device 106B for example.

The scheduler device 102 may solve a system of scheduling equations to create the schedule for the switches 104 of the nodes 105 to send Ethernet frames in a time-sensitive manner through the time-sensitive network 109. This schedule may be subject to various constraints, such as the topology of the network 109, the speed of communication by and/or between switches 104 in the network 109, the amount of Ethernet frames to be communicated through different switches 104, etc. This schedule can be created to avoid two or more Ethernet frames colliding with each other at a switch 104 (e.g., to prevent multiple frames from being communicated through the same switch 104 at the same time).

The scheduler device 102 may be formed from hardware circuitry that is connected with and/or includes one or more processors that generate the schedule for the time-sensitive network 109. The one or more processors of the scheduler device 102 may be disposed at the switch 104 of a single node 105, may be distributed among the switches 104 of multiple nodes 105, or may be separate and discrete from the nodes 105. The scheduler device 102 is synchronized with the grandmaster clock device 110 of the control system 107. The grandmaster clock device 110 includes a clock to which the clocks 112 of the nodes 105 are synchronized.

The centralized network configurator device 108 (referred to herein as configurator device 108) of the control system 107 is comprised of software and/or hardware that has knowledge of the physical topology of the time-sensitive network 109 as well as the traffic flow paths 120. The configurator device 108 can be formed from hardware circuitry that is connected with and/or includes one or more processors that determine or otherwise obtain the topology information from the nodes 105 and/or user input.

The physical topology of the time-sensitive network 109 maps the hardware of the network 109, including the locations (e.g., absolute and/or relative locations) of all of the nodes 105, the computing devices 106, and the links 103 that connect the nodes 105 and the computing devices 106. The topology can also identify which of the nodes 105 are directly coupled with other nodes 105 and/or the computing devices 106 via links 103. The locations of the hardware components can be used to determine distances between the hardware components, which may be utilized by the configurator device 108 when establishing redundant flow paths that are (expected to be) able to convey data frames within designated time windows according to the schedule. The physical topology may also include additional information about the hardware within the network 109, such as the types of hardware (e.g., part numbers), the operational ages of the hardware (e.g., how long a given switch 104 has been in operation in the current time-sensitive network 109 and any previous networks), manufacturer-provided mean time before failure (MTBF) values or estimates for the hardware, instructions for communicating with the various nodes 105 and other hardware, and the like.

The topology information may be stored in a database and accessed by the configurator device 108. Alternatively, the configurator device 108 may generate the topology information by communicating with the nodes 105 in the network 109 to determine the types and locations (relative or absolute) of the nodes 105. The configurator device 108 can provide this topology information to the scheduler device 102, which uses the topology information to determine the schedules for communication of messages between the computing devices 106. The configurator device 108 and/or scheduler device 102 can communicate the schedule to the different nodes 105. The configurator device 108 also uses the topology information to perform a reliability analysis on the time-sensitive network 109, as described herein.

The hardware circuitry and/or processors of the configurator device 108 can be at least partially shared with the hardware circuitry and/or processors of the scheduler device 102. For example, one or more processors and associated circuitry may be configured to perform the operations of both the configurator device 108 and the scheduler device 102 as described herein. Alternatively, the one or more processors of the configurator device 108 are all discrete and separate from the one or more processors of the scheduler device 102. In yet another embodiment, a subset of processors of the configurator device 108 is shared in common with the scheduler device 102, and/or a subset of processors of the scheduler device 102 is shared in common with the configurator device 108.

The control system 107 (e.g., the scheduler device 102) may communicate with the time-aware nodes 105 (e.g., the switches 104 with respective clocks 112) through a network management protocol. For example, a link layer discovery protocol can be used to exchange information between the scheduler device 102 and the nodes 105. The nodes 105 may implement a control plane element that forwards the commands from the scheduler device 102 to their respective hardware. The configurator device 108 may poll the nodes 105 and the computing devices 106 to retrieve topology information of the time-sensitive network 109 via the network management protocol.

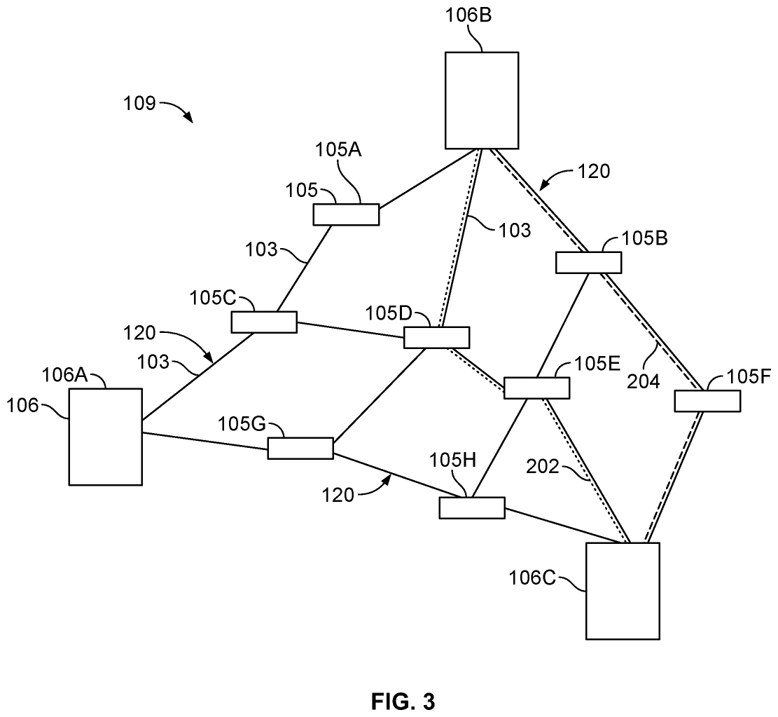

FIG. 3 illustrates the time-sensitive network 109 of FIG. 2 with multiple computing devices 106 and traffic flow paths 120 communicatively connecting the computing devices 106. The control system 107 of the communication system 100 (shown in FIG. 2) is omitted in FIG. 3. As described above, plural computing devices 106 (e.g., devices 106A, 106B, 106C in FIG. 3) communicate frames of messages with each other on a schedule dictated by the scheduler device 102 (shown in FIG. 2). The frames are sent between the devices 106A-C along the traffic flow paths 120 that are defined by the links 103 and the nodes 105 (e.g., nodes 105A-H in FIG. 3). Due to the number of nodes 105A-H and links 103 connecting the nodes 105A-H, there may be multiple different paths 120 between each pair of the three computing devices 106A-C.

For example, data frames can be transmitted along multiple paths 120 from the first computing device 106A to the second computing device 106B. The schedule may dictate that frames representing time-critical messages are exchanged along a first path 120 formed by nodes 105A, 105C (and the links 103 between the nodes 105A, 105C and the computing devices 106A, 106B). The paths 120 may be referred to herein by identifying the nodes 105 within the paths 120, without specific reference to the links 103 within the paths 120 that connect the identified nodes 105 and the corresponding computing devices 106. The schedule may dictate that frames representing best-effort messages are exchanged along a different, second path 120 that does not include any of the same links 103 or nodes 105A, 105C as the first path 120, or that includes at least one different link 103 or node 105 from the first path 120. For example, the second path 120 may be defined by the nodes 105C, 105D, such that the node 105C is a part of both the first and second paths 120. Alternatively, the second path 120 may be defined by the nodes 105D, 105G, such that the second path 120 has no components in common with the first path 120.

In at least one embodiment, the configurator device 108 is configured to establish or define one or more redundant traffic flow paths 202 (referred to herein as redundant paths 202) through the time-sensitive network 109 in increase the reliability of the network 109. For example, the configurator device 108 may maintain the existing flow of data frames through the network 109 along the designated paths 120 according to the schedule, and may establish a redundant path 202 to bypass a corresponding path 120 that is determined to have a lower reliability than other paths 120 in the network 109. The corresponding path 120 that is bypassed is referred to herein as a low reliability path 204. Data frames that are exchanged along the low reliability path 204 according to the schedule may be transmitted in parallel along the redundant path 202. Transmitting the data frames along both the low reliability path 204 and the redundant path 202 increases the likelihood that the data frames are received by the listening device within the narrow designated time window mandated by the schedule. The one or more redundant paths 202 are established to ensure that time-sensitive frames are successfully communicated between the devices 106 within designated time limits. For example, if a data frame transmitted along the low reliability path 204 fails to be received at the listening device within the scheduled time window due to hardware failure or the like, a duplicate copy of the data frame transmitted in parallel along the redundant path 202 is likely to be successfully received at the listening device within the time window.

It is noted that the low reliability path 204 is a properly functioning communication flow pathway that has not failed and is not damaged or dysfunctional. The path 204 is referred to as a low reliability path because it is calculated or determined that the path 204 has a greater probability of failure relative to one or more other paths 120 in the network 109 or relative to a preset non-zero threshold. For example, a path 120 may be designated as a low reliability path 204 even in the probability of failure is determined to be very low, such as 0.00001% for example, as long as the probability is greater than other paths 120 and/or the preset threshold. This probability of failure optionally can be referred to as a communication risk or communication risk value.

Although parallel traffic flows utilizing redundant paths 202 increase the likelihood of successful transmission of data frames according to the schedule, it may not be feasible, practical, and/or cost-effective to define a redundant path 202 for every path 120 in the network 109 due to added complexity, added energy and processing required, added cost, and/or latency effects. In at least one embodiment, the configurator device 108 establishes a sufficient number of redundant paths 202 to satisfy a designated network reliability target (e.g., network communication success rate), but does not establish additional redundant paths 202 beyond what is necessary to satisfy the network reliability target.

In order to determine the number of redundant paths 202 to establish in the time-sensitive network 109, and the locations thereof, the configurator device 108 performs a reliability analysis on the hardware in the network 109. The reliability analysis includes determining probability of failure values for each path 120 of multiple paths 120 through the network 109. The probability of failure value indicates how reliable a given path 120 is calculated to be. The probability of failure value indicates how likely a path 120 will fail to deliver a data frame to a listening device within a designated time window according to the schedule. Ethernet communications are generally reliable, but a failure may occur in various scenarios. For example, a failure may occur if hardware along the path 120 malfunctions, such as a cable that defines a link 103 breaking or disconnecting from a switch 104. The failure may also occur if, due to interference or delay, two data frames collide along the same path 120.

The probability of failure values is determined at least in part on the known topology of the network 109 because the configurator device 108 identifies the number and types of hardware components in each of the paths 120. For example, longer paths 120 may have a greater probability of failure than shorter paths 120 including the same types of components because there are more components that have to function properly to successfully transmit a data frame on schedule. The types of hardware components (e.g., links 103, nodes 105 and switches 104 thereof, etc.) in the paths 120 may also be utilized to calculate the probability of failure values. For example, some hardware devices may be manufactured with greater quality and more reliable performance than other types of devices. The manufacture may provide quantitative indicators of reliability with the components. For example, a manufacturer may label a hardware device with a mean time before failure (MTBF) value, which is basically a failure rate associated with the device. In a non-limiting example, the MTBF value may be based on time of operation. A switch 104 may have a MTBF value of 10 years, indicating that the switch 104 is unlikely to malfunction within the first 10 years of operation. Alternatively, the MTBF value may be based on number of communications transmitted, such that an example MTBF value may be twenty million successful data transmissions for every failure. The MTBF values may be set by the manufacturers and may be communicated to the configurator device 108 using the link layer discovery protocol.

In an embodiment, a probability of failure value for a given path 120 is determined by identifying the hardware components in the path 120 and then determining the MTBF values for each of the hardware components based on the type of hardware and optionally the operating age of the hardware. For example, a new switch 104 with less than one year of operation may have a lower probability of failure than the same type of switch 104 with eight years of operation, due to material degradation or the like. It is recognized that the MTBF values may be specific to sub-components within a node 105, such as specific ports, electrical switches, and the like.

Once the configurator device 108 determines the MTBF values for the hardware components (e.g., links 103 and nodes 105) that define a given path 120, the configurator device 108 may calculate a single probability of failure value for the path 120 based on the multiple MTBF values. For example, the configurator device 108 may perform a series reduction that combines the MTBF values for the components linked in series. The series reduction accounts for the number of components in the path 120. The configurator device 108 may perform the same operation on all paths 120 in the network 109 to determine the probability of failure values. It is recognized that many of the paths 120 have at least one hardware component in common with at least one other path 120. Because Ethernet communications are generally reliable, the probability of failure values for the paths 120 in the time-sensitive network 109 may be very low, such as 10⁻⁶%, 10⁻⁸%, or 10⁻¹⁰%.

After determining the reliability of the individual paths 120 by calculating the probability of failure values, the configurator device 108 configures the time-sensitive network 109 to define or establish at least one redundant path 202 for the purpose of improving the reliability of the network 109. The configurator device 108 first identifies one or more low reliability paths 204 based on the probability of failure values. The low reliability paths 204 have greater probability of failure values than one or more of the other paths 120 in the network 109, and therefore are more likely to fail. The low reliability paths 204 may be selected by choosing a designated number of the paths 120 having the greatest calculated probability of failure values. The designated number of low reliability paths 204 may be pre-selected by an operator, such as two, three, or five, or may be calculated based on a network reliability target, as described herein. Alternatively, the low reliability paths 204 may be selected based on a designated threshold, such that any path 120 having a probability of failure value greater than the threshold is labeled as a low reliability path 204. The threshold may be selected by an operator, set by a standard, or the like.

In an embodiment, the configurator device 108 obtains a network reliability target that represents a designated network communication success rate. For example, the network reliability target designates a threshold level of reliability across the entire time-sensitive network 109. In a non-limiting example, the network reliability target may be 99.999999%. It is recognized that success rates can be converted to failure rates by subtracting the success rate from 1.0. Therefore, the network reliability target may also refer to a designated network communication failure rate, such as 0.000001%. The network reliability target may be selected by an operator or set by a standard. The configurator device 108 utilizes the network reliability target as a constraint when configuring the time-sensitive network 109 to define at least one redundant path 202. For example, the configurator device 108 defines a sufficient number of redundant paths 202 to satisfy the network reliability target.

Prior to defining the redundant paths 202, the configurator device 108 may calculate the current network reliability of the time-sensitive network 109 by performing a series-parallel reduction on the entire topology of the network 109 based on the probability of failure values associated with the individual hardware components. The series-parallel reduction yields a single probability of failure value (e.g., a single network reliability value) for the entire network 109. If the reliability value for the existing network 109 satisfies the network reliability target, then the configurator device 108 may use the current network configuration without defining any redundant paths 202. If the reliability value for the existing network 109 without redundant paths 202 fails to satisfy the network reliability target, then the configurator device 108 defines one or more redundant paths 202 to increase the network reliability.

The one or more redundant paths 202 are defined to bypass corresponding low reliability paths 204. To define a redundant path 202, the configurator device 108 first identifies the location of a low reliability path 204 in the network 109. For example, referring to FIG. 3, a low reliability path 204 between the computing devices 106B, 106C may be the path 120 defined along the nodes 105B, 105F. The low reliability path 204 may be selected because it is determined to have the greatest probability of failure value out of the existing paths 120 in the network 109. The redundant path 202 is defined as a path that has at least one different hardware component (e.g., link 103 or node 105) from the low reliability path 204. In the illustrated embodiment, the redundant path 202 is defined or established along the path 120 through the nodes 105D, 105E.

According to at least one embodiment, the redundant path 202 is selected by the configurator device 108 as a path that is feasible according to various constraints, such as the given topology, requested flow latency, frame sizes, and/or the like. For example, the redundant path 202 has to be able to transmit the data frames to the listening device within the narrow-scheduled time windows according to the schedule of the time-sensitive network 109. The configurator device 108 may factor in the number of hardware components in a path 120 and the overall length of a path 120 when determining if the path 120 is to be used as a redundant path 202. For example, paths 120 having longer lengths and/or more nodes 105 (e.g., which gate the data frames) than other paths 120 may not be able to transmit the data frames to a destination listening device as timely as the other paths 120.

Furthermore, the schedule may dictate the times in which switches 104 of the nodes 105 along the selected path 120 gate (e.g., block transmission) and transmit the data frames. Based on traffic (e.g., other data frames) directed through a node 105 along a candidate path 120, the node 105 may not be able to gate and transmit a duplicate data frame according to the precise times dictated by the schedule. Whether due to pathway length, traffic congestion at a node 105, or the like, candidate paths 120 that are not able to transmit the duplicate data frame to the destination listening device within the narrow time windows of the schedule are not selected as redundant paths 202 by the configurator device 108. Because the time-sensitive network 109 is used to convey time-critical messages, the redundant paths 202 are defined with the expectation that the redundant paths 202 are able to satisfy the network schedule. The configurator device 108 may refer to the schedule when defining the redundant paths 202.

For example, the time-sensitive network 109 may differ from typical Ethernet networks that transmit date frames along various data paths through the network to arrive at a designated destination in a best-effort time frame, such that there may not be a scheduled time window in which a data frame is required to be delivered. In addition to setting a narrow time window for delivery of each data frame at a respective listening device, the schedule of the time-sensitive network 109 may also specify the exact path 120 that the data frame is transmitted through the network 109. For example, a single data frame representative of at least a portion of a time-critical message may be conveyed along only one specific path 120, unless that path 120 is designated as a low reliability path 204 such that a duplicate copy of the data frame is transmitted in parallel along a single, specific redundant path 202. The constraints applied on the traffic flows of data frames through the time-sensitive network 109 may be more rigorous than typical Ethernet networks.

If the configurator device 108 is not able to utilize existing paths 120 within the network 109 as a redundant path 202 to bypass a given low reliability path 204 based on an inability of the paths 120 to satisfy the scheduling constraints, the configurator device 108 may generate an instruction message configured to prompt an operator or a machine to install an additional link 103 and/or an additional node 105 within the time-sensitive network 109. For example, it may be determined that the node 105F has a relatively high probability of failure value, but none of the existing paths 120 can satisfy the constraints for utilization as a redundant path 202 to bypass the low reliability path 204 that extends through the nodes 105B, 105F. In response, the configurator device 108 may generate an instruction message that prompts an operator or machine to install additional hardware to create a new path 120 that can function as the redundant path 202. For example, the new path 120 may be formed by installing a new link 103 from the computing device 106C directly to the node 105B to bypass the unreliable node 105F. Optionally, a new node 105 may be installed in addition to at least one new link 103.

Optionally, the redundant paths 202 may only be defined to bypass low reliability paths 204 that are used to exchange time-critical messages. For example, if the path 120 determined to have the greatest probability of failure within the network 109 is scheduled to only exchange best-effort messages between the computing devices 106, then the configurator device 108 does not define a redundant path 202 to bypass this low reliability path 204. If, on the other hand, this low reliability path 204 is scheduled to exchange time-critical messages (with or without also exchanging best-effort messages), then the configurator device 108 defines a redundant path 202 to bypass this low reliability path 204. For example, the configurator device 108 may be configured to ensure that the time-critical messages arrive on time, not the best-effort messages. In an alternative embodiment, the configurator device 108 may be configured to define redundant paths 202 to bypass a low reliability path 204 regardless of the type of messages exchanged along the path 204.

In an embodiment, the configurator device 108 defines or establishes a sufficient number of redundant paths 202 within the network 109 to satisfy the network reliability target. For example, upon defining a first redundant path 202 around a first low reliability path 204, the configurator device 108 may perform a network-wide series-parallel reduction to calculate current network reliability. By adding the first redundant path 202 to transmit duplicate data in parallel with the low reliability path 204, the series-parallel reduction indicates that the network reliability is greater with the first redundant path 202 than without the first redundant path 202. The configurator device 108 compares the current network reliability to the network reliability target. If the current network reliability satisfies the network reliability target, then the configurator device 108 does not define any additional redundant paths 202, which advantageously avoids the additional complexity, processing requirements, energy usage, and cost associated with having multiple redundant traffic flow paths. But if the current network reliability is still below the network reliability target, then the configurator device 108 defines a second redundant path 202 to bypass a second low reliability path 204 in the network 109. For example, the configurator device 108 may be configured to define a sufficient number of redundant paths 202 to satisfy the network reliability target, but no more than that number required to satisfy the network reliability target.

After configuring the time-sensitive network 109 to define one or more redundant flow paths 202, the time-sensitive network 109 is operated to transmit time-sensitive messages between the computing devices 106 (e.g., devices 106A-C). For example, a data frame of a time-critical message that is scheduled to be transmitted from the computing device 106B to the computing device 106C along the low reliability path 204 through the nodes 105B, 105F is copied or duplicated such that a duplicate data frame is transmitted in parallel along the redundant path 202 through the nodes 105D, 105E. The data frame may be duplicated at a device that is shared by both of the paths 202, 204. In the illustrated embodiment, the data frame is duplicated at the publishing computing device 106B. In another embodiment, a node 105 in which a redundant path 202 splits from a low reliability path 204 duplicates the data frame and transmits the duplicate copies of the data frame along the two different paths 202, 204.

The duplicate copies of the data frame may be merged at a device that is shared by both of the paths 202, 204. In the illustrated embodiment, the duplicate copies may be merged at the listening computing device 106C. In another embodiment, a node 105 in which a redundant path 202 merges with a low reliability path 204 may merge or combine the duplicate copies of the data frame such that a single copy of the data frame is transmitted along a remainder of the path 120 to the designated listening device.

Optionally, only the data frames of time-critical messages are duplicated and transmitted in parallel along both a low reliability path 204 and a redundant path 202. The data frames representing best-effort messages may not be duplicated and may be exchanged along a single path 120. For example, a data frame representing a best-effort message transmitted along the low reliability path 204 through the nodes 105B, 105F may not be duplicated such that a copy of the data frame is transmitted in parallel along the redundant path 202 through the nodes 105D, 105E. Alternatively, even the best-effort data frames scheduled for transmission along low reliability paths 204 are duplicated and transmitted in parallel along the redundant path 202.

During operation of the time-sensitive network 109, the configurator device 108 may reconfigure or update the redundant paths 202 to accommodate dynamic redundancy changes. For example, network hardware devices, such as the nodes 105, may periodically (or on command) report respective updated probability of failure values (e.g., a reliability metric) to the configurator device 108 and/or the scheduler device 102 via a standards-based network protocol. The reporting may be dynamic, such that a given node 105 may report that it has just experienced a fault. In response, the configurator device 108 may reconfigure the time-sensitive network 109 based on the updated probability of failure values to modify the existing redundant paths 202 and/or add an additional redundant path 202. The redundant paths 202 may be updated to maintain the designated network reliability target. Optionally, another response may be for the scheduler device 102 to generate an updated schedule based on the updated reliability metrics. For example, the updated schedule may dictate that only best-effort messages (no time-critical messages) are communicated along the paths 120 defined in part by the node 105 that experienced the fault.

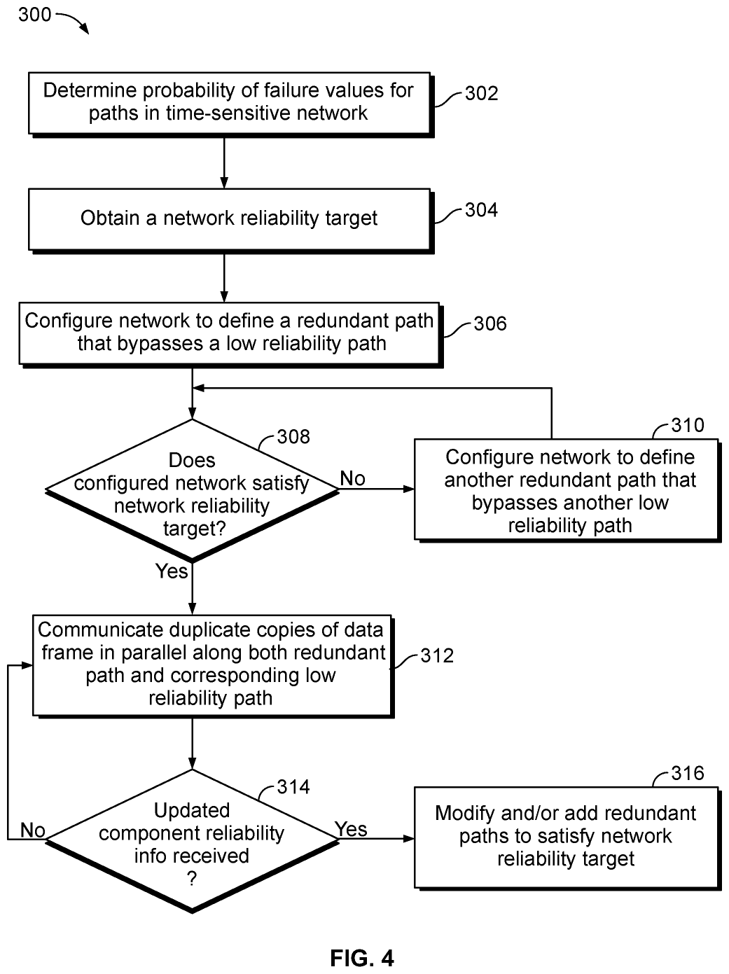

FIG. 4 illustrates a flowchart of one embodiment of a method 300 for communications, and more specifically to reliably communicating messages in a time-sensitive network. The method 300 can represent operations performed by the control system 107 (e.g., by the configurator device 108 and/or the scheduler device 102) of the communication system 100. At 302, a probability of failure value is determined for each path of multiple paths 120 within a time-sensitive network 109. The multiple paths 120 are defined by multiple nodes 105 and links 103 that communicatively connect the nodes 105 and computing devices 106 that send and receive (e.g., publish and listen to) time-sensitive messages along the network 109.

At 304, a network reliability target that represents a designated network communication success rate is obtained. At 306, the time-sensitive network 109 is configured based on the probability of failure values to define a redundant path 202 of the paths 120 that bypasses a corresponding low reliability path 204 of the paths 120. The low reliability path 204 has a greater probability of failure value than one or more of the other paths 120 in the time-sensitive network 109. The redundant path 202 includes at least one different link 103 or node 105 from the low reliability path 204. The configuring of the time-sensitive network 109 may involve defining more than one redundant path 202 in the time-sensitive network 109 to satisfy the network reliability target.

For example, at 308, it is determined whether the current configuration of the network 109 (e.g., having only a first redundant path 202), satisfies the network reliability target. If so, the method 300 proceeds to 312 and Ethernet data frames are communicated through the network 109 between computing devices 106 according to a schedule. If not, then the method 300 proceeds to 310, and the network 109 is configured to define another redundant path 202 that bypasses another low reliability path 204. Then the method 300 returns to 308 for another determination of whether the current configuration of the network 109 (e.g., having now two redundant paths 202), satisfies the network reliability target. Flow proceeds to 312 once there are a sufficient number of redundant paths 202 to satisfy the network reliability target.

At 312, during the operation of the time-sensitive network 109, duplicate copies of a data frame are communicated in parallel along both the redundant path 202 and the low reliability path 204 to increase a likelihood that the data frame is received at a listening device from a publishing device within a designated time window according to a schedule of the time-sensitive network 109. The data frame may represent a time-critical message.

At 314, it is determined whether updated component reliability information is received. The component reliability information may be reliability information relating to the nodes 105 and/or the links 103. If no updated component reliability information is received (or the reliability information is received but is within a threshold range of current reliability information), then flow returns to 312 and the time-sensitive network 109 continues to operate to transmit time-critical messages and best-effort messages according to the schedule. On the other hand, if the updated component reliability information is indeed received (and is outside of a threshold range from the current reliability information), then flow proceeds to 316.

At 316, an updated probability of failure value is determined for each of the multiple paths 120 (subsequent to communicating the duplicate copies of the data frame in parallel along both the redundant path 202 and the low reliability path 204 according to the schedule, according to step 312). The time-sensitive network 109 is reconfigured based on the updated probability of failure values to modify the redundant path(s) 202 and/or add one or more additional redundant paths 202 to maintain the network reliability target.

In one embodiment, a communication system includes one or more processors configured to determine a communication risk value for each path of multiple paths between nodes and links between the nodes within a time-sensitive network. The one or more processors also are configured to determine that at least one of the paths is a low reliability path due to the low reliability path having a communication risk value than one or more other paths in the time-sensitive network. The one or more processors also are configured to establish a redundant path of the paths that bypasses the low reliability path such that the redundant path includes at least one different link or node from the low reliability path. The one or more processors also are configured to control the time-sensitive network to communicate duplicate copies of a data frame in parallel along both the redundant path and the low reliability path between a publishing device and a listening device within a designated time window according to a schedule of the time-sensitive network.

Optionally, the one or more processors are configured to select a length and location of the redundant path so that the data frame is communicated via the redundant path from the publishing device to the listening device within the designated time window according to the schedule even while the low reliability path fails to communicate the data frame from the publishing device to the listening device within the designated time window.

Optionally, the data frame is a first data frame that is at least part of a time-critical message of the time-sensitive network. The one or more processors can be configured to direct communication of a second data frame that is at least part of a best-effort message of the time-sensitive network along only one of the paths in the time-sensitive network without duplicating communication of the second data frame along another of the paths in the time-sensitive network.

Optionally, the one or more processors are configured to determine the communication risk value for each of two or more of the paths based at least in part on a number of the nodes in the corresponding path, a number of the links in the corresponding path, and predefined mean time before failure (MTBF) values associated with the nodes and the links in the corresponding path.

Optionally, the one or more processors are configured to determine a network reliability target that represents a designated network communication success rate. The one or more processors can be configured to establish both the redundant path and at least one additional redundant path in the time-sensitive network so that a measured network reliability value satisfies the network reliability target.

Optionally, the one or more processors are configured to calculate a threshold number of redundant paths needed to satisfy a network reliability target that represents a designated network communication success rate. The one or more processors can be configured to establish multiple instances of the redundant path equal to the threshold number.

Optionally, the one or more processors are configured to establish the redundant path by generating an instruction message to install at least one of an additional link or an additional node within the time-sensitive network.

Optionally, the one or more processors are configured to determine an updated communication risk value for two or more of the multiple paths subsequent to communicating the duplicate copies of the data frame in parallel along both the redundant path and the low reliability path according to the schedule. The one or more processors can be configured to at least one of modify the redundant path or add an additional redundant path based on the updated communication risk values.

In one embodiment, a method includes determining a communication risk value for each path of multiple paths between nodes and links between the nodes within a time-sensitive network, determining that at least one of the paths is a low reliability path due to the low reliability path having a greater communication risk value than one or more other paths in the time-sensitive network, establishing a redundant path of the paths that bypasses the low reliability path such that the redundant path includes at least one different link or node from the low reliability path, and directing the time-sensitive network to communicate duplicate copies of a data frame in parallel along both the redundant path and the low reliability path between a publishing device and a listening device within a designated time window according to a schedule of the time-sensitive network.

Optionally, establishing the redundant path includes selecting a length and location of the redundant path so that the data frame is communicated via the redundant path from the publishing device to the listening device within the designated time window according to the schedule even while the low reliability path fails to communicate the data frame from the publishing device to the listening device within the designated time window.

Optionally, the data frame is a first data frame that is at least part of a time-critical message of the time-sensitive network. The method also can include directing communication of a second data frame that is at least part of a best-effort message of the time-sensitive network along only one of the paths in the time-sensitive network without duplicating communication of the second data frame along another of the paths in the time-sensitive network.

Optionally, the communication risk value is determined for each of two or more of the paths based at least in part on a number of the nodes in the corresponding path, a number of the links in the corresponding path, and predefined mean time before failure (MTBF) values associated with the nodes and the links in the corresponding path.

Optionally, the method also includes determining a network reliability target that represents a designated network communication success rate. The redundant path and at least one additional redundant path can be established in the time-sensitive network. The redundant path and the at least one additional redundant path can be established so that a measured network reliability value satisfies the network reliability target.

Optionally, the method also includes determining a threshold number of redundant paths needed to satisfy a network reliability target that represents a designated network communication success rate. Multiple instances of the redundant path that are equal to the threshold number can be established. For example, each instance of the redundant path may be another, different redundant path.

Optionally, the redundant path is established by generating an instruction message to install at least one of an additional link or an additional node within the time-sensitive network.

In one embodiment, a communication system includes a time-sensitive network including plural network paths formed by nodes interconnected by communication links. The nodes are configured to receive and forward data frames of a message between each other along the communication links to communicate the message originating at a publishing device to one or more listening devices within a designated time window according to a schedule of the time-sensitive network. The communication system also includes one or more processors configured to determine communication risk values for two or more of the network paths within a time-sensitive network that communicatively couple the publishing device with the one or more listening devices. The one or more processors also are configured to compare the communication risk values of the paths and to establish a redundant path that communicatively couples the publishing device with the one or more listening devices from one or more of the nodes and two or more of the communication links already existing in the time-sensitive network based on the communication risk values that are compared. The redundant path is established to bypass at least one other network path of the network paths between the publishing device and the one or more listening devices. The one or more processors also are configured to control the time-sensitive network to communicate duplicate copies of at least one of the data frames in parallel along both the redundant path and the at least one other network path from the publishing device to the one or more listening devices within the designated time window of the schedule of the time-sensitive network.

Optionally, the one or more processors are configured to select a length and location of the redundant path so that the at least one data frame is communicated via the redundant path from the publishing device to the one or more listening devices within the designated time window according to the schedule even while the at least one other network path fails to communicate the data frame from the publishing device to the one or more listening devices within the designated time window.

Optionally, the at least one data frame is a first data frame that is at least part of a time-critical message of the time-sensitive network. The one or more processors can be configured to direct communication of a second data frame that is at least part of a best-effort message of the time-sensitive network along only one of the network paths in the time-sensitive network without duplicating communication of the second data frame along any other of the network paths in the time-sensitive network.

Optionally, the one or more processors are configured to determine the communication risk value for each of two or more of the paths based at least in part on a number of the nodes in the corresponding path, a number of the links in the corresponding path, and predefined mean time before failure (MTBF) values associated with the nodes and the links in the corresponding path.

Optionally, the one or more processors are configured to determine an updated communication risk value for two or more of the network paths subsequent to communicating the duplicate copies of the at least one data frame in parallel along both the redundant path and the at least one other network path according to the schedule. The one or more processors can be configured to at least one of modify the redundant path or add an additional redundant path based on the updated communication risk values.

In one or more embodiments, a method (e.g., for locomotive communications) is provided that includes determining a probability of failure value for each path of multiple paths within a time-sensitive network onboard one or more locomotives of a vehicle system. The multiple paths are defined by multiple nodes and links that communicatively connect the nodes. The method includes configuring the time-sensitive network based on the probability of failure values to define a redundant path of the paths that bypasses a low reliability path of the paths that has a greater probability of failure value than one or more of the other paths in the time-sensitive network. The redundant path includes at least one different link or node from the low reliability path. The method also includes communicating duplicate copies of a data frame in parallel along both the redundant path and the low reliability path to increase a likelihood that the data frame is received at a listening device from a publishing device within a designated time window according to a schedule of the time-sensitive network.

Optionally, a length and location of the redundant path is selected to enable the redundant path to communicate the data frame to the listening device within the designated time window according to the schedule.

Optionally, the data frame that is communicated along both the redundant path and the low reliability path represents a time-critical message within the time-sensitive network. Optionally, the method further includes communicating another data frame that represents a best-effort message along only one of the paths in the time-sensitive network without duplicating the other data frame. The best-effort message has a lower priority than the time-critical message.

Optionally, the method further includes generating the duplicate copies of the data frame at a first shared node of the nodes that is part of both the redundant path and the low reliability path. Optionally, the method further includes receiving and merging the duplicate copies at a second shared node of the nodes that is part of both the redundant path and the low reliability path.

Optionally, the probability of failure value for each of the paths is determined based at least in part on the number of the nodes and the links in the path and predefined mean time before failure (MTBF) values associated with the nodes and the links in the path.

Optionally, the method further includes obtaining a network reliability target representing a designated network communication success rate. The configuring of the time-sensitive network includes defining the redundant path and at least one additional redundant path in the time-sensitive network to satisfy the network reliability target.

Optionally, the method further includes calculating a threshold number of redundant paths necessary to satisfy a network reliability target that represents a designated network communication success rate. The time-sensitive network is configured by defining a total number of redundant paths in the time-sensitive network equal to the threshold number.

Optionally, configuring the time-sensitive network to define the redundant path includes generating an instruction message to install an additional link and/or an additional node within the time-sensitive network.

Optionally, the method further includes determining an updated probability of failure value for each of the multiple paths subsequent to communicating the duplicate copies of the data frame in parallel along both the redundant path and the low reliability path according to the schedule. The method also includes reconfiguring the time-sensitive network based on the updated probability of failure values to modify the redundant path and/or add an additional redundant path.

In one or more embodiments, a locomotive communication system is provided that includes one or more processors onboard one or more locomotives of a vehicle system. The one or more processors are configured to determine a probability of failure value for each path of multiple paths within a time-sensitive network onboard the vehicle system. The multiple paths are defined by multiple nodes and links that communicatively connect the nodes. The one or more processors are configured to establish a redundant path of the paths that bypasses a low reliability path of the paths that has a greater probability of failure value than one or more of the other paths in the time-sensitive network. The redundant path includes at least one different link or node from the low reliability path. The one or more processors are also configured to control the time-sensitive network to communicate duplicate copies of a data frame in parallel along both the redundant path and the low reliability path to increase a likelihood that the data frame is received at a listening device from a publishing device within a designated time window according to a schedule of the time-sensitive network.

Optionally, the one or more processors select a length and location of the redundant path to enable the redundant path to communicate the data frame to the listening device within the designated time window according to the schedule even if the low reliability path fails to communicate the data frame to the listening device within the designated time window.

Optionally, the data frame that is communicated along both the redundant path and the low reliability path represents a time-critical message. The one or more processors communicate a second data frame representing a best-effort message along only one of the paths in the time-sensitive network without duplicating the second data frame.

Optionally, the one or more processors are configured to determine the probability of failure value for each of the paths based at least in part on the number of the nodes and the links in the corresponding path and predefined mean time before failure (MTBF) values associated with the nodes and the links in the path.

Optionally, the one or more processors are configured to receive a network reliability target that represents a designated network communication success rate. The one or more processors establish both the redundant path and at least one additional redundant path in the time-sensitive network to satisfy the network reliability target.

Optionally, the one or more processors are configured to calculate a threshold number of redundant paths necessary to satisfy a network reliability target that represents a designated network communication success rate. The one or more processors establish a total number of redundant paths in the time-sensitive network equal to the threshold number.

Optionally, the one or more processors establish the redundant path by generating an instruction message to install an additional link and/or an additional node within the time-sensitive network.

Optionally, the one or more processors are further configured to determine an updated probability of failure value for each of the multiple paths subsequent to communicating the duplicate copies of the data frame in parallel along both the redundant path and the low reliability path according to the schedule. The one or more processors modify the redundant path and/or add an additional redundant path based on the updated probability of failure values.

In one or more embodiments, a method (e.g., for locomotive communications) is provided that includes determining a probability of failure value for each path of multiple paths within a time-sensitive network onboard one or more locomotives of a vehicle system. The multiple paths are defined by multiple nodes and links that communicatively connect the nodes. The method includes receiving a network reliability target representing a designated network communication success rate, and establishing one or more redundant paths of the paths to satisfy the network reliability target. Each of the one or more redundant paths bypasses a corresponding low reliability path of the paths that has a greater probability of failure value than one or more of the other paths in the time-sensitive network. Each of the one or more redundant paths includes at least one different link or node from the corresponding low reliability path. Each of the one or more redundant paths communicates a data frame in parallel with a duplicate copy of the data frame communicated along the corresponding low reliability path to increase a likelihood that the data frame is received at a listening device from a publishing device within a designated time window according to a schedule of the time-sensitive network.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising,” “including,” and “having” an element or a plurality of elements with a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are example embodiments. Many other embodiments will be apparent to those of ordinary skill in the art upon reviewing the above description. The scope of the subject matter described herein should, therefore, be determined with reference to the appended claims, along with the full scope of equivalents to which such claims are entitled. In the appended claims, the terms “including” is used as the plain-English equivalents of the term “comprising.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A communication system comprising:
one or more processors configured to determine a communication risk value for each path of multiple paths between nodes and links between the nodes within a time-sensitive network, the one or more processors also configured to determine that at least one of the paths is a low reliability path due to the low reliability path having a communication risk value than one or more other paths in the time-sensitive network,
wherein the one or more processors also are configured to establish a redundant path of the paths that bypasses the low reliability path such that the redundant path includes at least one different link or node from the low reliability path, and
wherein the one or more processors also are configured to control the time-sensitive network to communicate duplicate copies of a data frame in parallel along both the redundant path and the low reliability path between a publishing device and a listening device within a designated time window according to a schedule of the time-sensitive network.

2. The communication system of claim 1, wherein the one or more processors are configured to select a length and location of the redundant path so that the data frame is communicated via the redundant path from the publishing device to the listening device within the designated time window according to the schedule even while the low reliability path fails to communicate the data frame from the publishing device to the listening device within the designated time window.

3. The communication system of claim 1, wherein the data frame is a first data frame that is at least part of a time-critical message of the time-sensitive network, and
wherein the one or more processors are configured to direct communication of a second data frame that is at least part of a best-effort message of the time-sensitive network along only one of the paths in the time-sensitive network without duplicating communication of the second data frame along another of the paths in the time-sensitive network.

4. The communication system of claim 1, wherein the one or more processors are configured to determine the communication risk value for each of two or more of the paths based at least in part on a number of the nodes in the corresponding path, a number of the links in the corresponding path, and predefined mean time before failure (MTBF) values associated with the nodes and the links in the corresponding path.

5. The communication system of claim 1, wherein the one or more processors are configured to determine a network reliability target that represents a designated network communication success rate, and
wherein the one or more processors are configured to establish both the redundant path and at least one additional redundant path in the time-sensitive network so that a measured network reliability value satisfies the network reliability target.

6. The communication system of claim 1, wherein the one or more processors are configured to calculate a threshold number of redundant paths needed to satisfy a network reliability target that represents a designated network communication success rate, and
wherein the one or more processors are configured to establish multiple instances of the redundant path equal to the threshold number.

7. The communication system of claim 1, wherein the one or more processors are configured to establish the redundant path by generating an instruction message to install at least one of an additional link or an additional node within the time-sensitive network.

8. The communication system of claim 1, wherein the one or more processors are configured to determine an updated communication risk value for two or more of the multiple paths subsequent to communicating the duplicate copies of the data frame in parallel along both the redundant path and the low reliability path according to the schedule, and
wherein the one or more processors are configured to at least one of modify the redundant path or add an additional redundant path based on the updated communication risk values.

9. A method comprising:
determining a communication risk value for each path of multiple paths between nodes and links between the nodes within a time-sensitive network;
determining that at least one of the paths is a low reliability path due to the low reliability path having a greater communication risk value than one or more other paths in the time-sensitive network;
establishing a redundant path of the paths that bypasses the low reliability path such that the redundant path includes at least one different link or node from the low reliability path; and
directing the time-sensitive network to communicate duplicate copies of a data frame in parallel along both the redundant path and the low reliability path between a publishing device and a listening device within a designated time window according to a schedule of the time-sensitive network.

10. The method of claim 9, wherein establishing the redundant path includes selecting a length and location of the redundant path so that the data frame is communicated via the redundant path from the publishing device to the listening device within the designated time window according to the schedule even while the low reliability path fails to communicate the data frame from the publishing device to the listening device within the designated time window.

11. The method of claim 9, wherein the data frame is a first data frame that is at least part of a time-critical message of the time-sensitive network, and further comprising:
directing communication of a second data frame that is at least part of a best-effort message of the time-sensitive network along only one of the paths in the time-sensitive network without duplicating communication of the second data frame along another of the paths in the time-sensitive network.

12. The method of claim 9, wherein the communication risk value is determined for each of two or more of the paths based at least in part on a number of the nodes in the corresponding path, a number of the links in the corresponding path, and predefined mean time before failure (MTBF) values associated with the nodes and the links in the corresponding path.

13. The method of claim 9, further comprising:
determining a network reliability target that represents a designated network communication success rate, and
wherein establishing the redundant path also includes establishing and at least one additional redundant path in the time-sensitive network, wherein the redundant path and the at least one additional redundant path are established so that a measured network reliability value satisfies the network reliability target.

14. The method of claim 9, further comprising:
determining a threshold number of redundant paths needed to satisfy a network reliability target that represents a designated network communication success rate,
wherein establishing the redundant path includes establishing multiple instances of the redundant path that are equal to the threshold number.

15. The method of claim 9, wherein the redundant path is established by generating an instruction message to install at least one of an additional link or an additional node within the time-sensitive network.

16. A communication system comprising:
a time-sensitive network including plural network paths formed by nodes interconnected by communication links, the nodes configured to receive and forward data frames of a message between each other along the communication links to communicate the message originating at a publishing device to one or more listening devices within a designated time window according to a schedule of the time-sensitive network; and
one or more processors configured to determine communication risk values for two or more of the network paths within a time-sensitive network that communicatively couple the publishing device with the one or more listening devices,
wherein the one or more processors also are configured to compare the communication risk values of the paths and to establish a redundant path that communicatively couples the publishing device with the one or more listening devices from one or more of the nodes and two or more of the communication links already existing in the time-sensitive network based on the communication risk values that are compared,
wherein the redundant path is established to bypass at least one other network path of the network paths between the publishing device and the one or more listening devices, and
wherein the one or more processors also are configured to control the time-sensitive network to communicate duplicate copies of at least one of the data frames in parallel along both the redundant path and the at least one other network path from the publishing device to the one or more listening devices within the designated time window of the schedule of the time-sensitive network.

17. The communication system of claim 16, wherein the one or more processors are configured to select a length and location of the redundant path so that the at least one data frame is communicated via the redundant path from the publishing device to the one or more listening devices within the designated time window according to the schedule even while the at least one other network path fails to communicate the data frame from the publishing device to the one or more listening devices within the designated time window.

18. The communication system of claim 16, wherein the at least one data frame is a first data frame that is at least part of a time-critical message of the time-sensitive network, and
wherein the one or more processors are configured to direct communication of a second data frame that is at least part of a best-effort message of the time-sensitive network along only one of the network paths in the time-sensitive network without duplicating communication of the second data frame along any other of the network paths in the time-sensitive network.

19. The communication system of claim 16, wherein the one or more processors are configured to determine the communication risk value for each of two or more of the paths based at least in part on a number of the nodes in the corresponding path, a number of the links in the corresponding path, and predefined mean time before failure (MTBF) values associated with the nodes and the links in the corresponding path.

20. The communication system of claim 16, wherein the one or more processors are configured to determine an updated communication risk value for two or more of the network paths subsequent to communicating the duplicate copies of the at least one data frame in parallel along both the redundant path and the at least one other network path according to the schedule, and
wherein the one or more processors are configured to at least one of modify the redundant path or add an additional redundant path based on the updated communication risk values.
